(19) United States
(12) Patent Application Publication
(10) Pub. No.: US 2025/0310894 A1
(43) Pub. Date: Oct. 2, 2025

(54) SOFTWARE-BASED CONFIGURATION OF THE POWER CLASS AND ADDITIONAL FUNCTIONS OF AN INVERTER

(71) Applicant: SMA Solar Technology AG, Niestetal (DE)

(72) Inventors: Matthias Gröne, Niestetal (DE); Dirk Firmenich, Göttingen (DE); Jörn Tümmler, Habichtswald (DE); Jens Wollenhaupt, Lohfelden (DE)

(21) Appl. No.: 19/233,095

(22) Filed: Jun. 10, 2025

Related U.S. Application Data
(63) Continuation of application No. PCT/EP2023/082957, filed on Nov. 24, 2023.

(30) Foreign Application Priority Data
Dec. 15, 2022 (DE) 10 2022 133 551.8

(51) Int. Cl. H04W 52/24; H04W 12/06

(52) U.S. Cl. CPC H04W 52/24; H04W 12/06

(57) ABSTRACT

The disclosure relates to a method for operating a power electronics device that includes checking, at the start of operation, whether exactly one activated power class profile is present from a plurality of different power class profiles, and only when exactly one activated power class profile is present, will a start of operation of the device be permitted under the conditions stored in the activated power class profile. In response to receiving a deactivation request from an authorized person, the activated power class profile is converted into a deactivated power class profile and a deactivation confirmation marked secret and stored on the device is sent to the authorized person. A corresponding power electronics device is likewise disclosed.

### REFERENCE TO RELATED APPLICATIONS

This application is a Continuation of International Application number PCT/EP2023/082957, filed on Nov. 24, 2023, which claims the benefit of German Application number 10 2022 133 551.8, filed on Dec. 15, 2022. The contents of the above-referenced Patent Applications are hereby incorporated by reference in their entirety.

### FIELD

The disclosure relates to a method for operating a power electronic device and a power electronic device that can be operated with a number of different power class profiles.

### BACKGROUND

The generation or conversion of electrical power using power electronic devices is becoming increasingly important, particularly in solar power systems, in which the power generated by solar modules as direct current is converted into alternating current for feeding into the grid that is compatible with the grid. Power electronic devices in the form of inverters are used for this purpose, the rated power of which is selected depending on the maximum power that can be generated by the solar modules. Therefore up to now, it has been necessary to offer a large number of inverter types with different rated powers in order to be able to optimally equip individually planned solar power systems.

For efficiency reasons, however, it is often more cost-effective for suppliers of such power electronic devices to offer a few or even just one device type for the required rated outputs instead of individual device types, whose rated output is only permanently set to the desired value during installation of the system. This setting must be tamper-proof, as the price of the power electronic device is regularly invoiced during installation and, on the other hand, overloading of the installation or reduced performance of the system must be avoided. For this purpose, a power class profile containing information about the rated power is stored and activated in the power electronic device. When operation begins, the power electronic device then checks whether an activated power class profile is available and operates the device in accordance with the rated power stored in the activated power class profile. Alternatively, the document ‘BPT-S 3-4.6 Operating Instructions’ from Bosch Power Tec GmbH describes that the language, country and standard settings for the respective location of an inverter are only made during commissioning using an RFID card on which the data required for the settings is stored. To do this, the installer holds the RFID card in a specified position on the inverter during an installation step described in the instructions, wherein the setting parameters are permanently transferred to the inverter. This procedure is not intended for selective billing of the power device activated in this way.

If a power electronic device with flexible activation of a number of power class profiles needs to be replaced, for example, due to a defect, it is desirable that the new device can be easily activated using the activated power class profile of the old device, wherein misuse is to be prevented in such a way that the continued operation of the old device is reliably prevented and only the activation of exactly one new device is enabled.

### SUMMARY

According to the disclosure, a method for operating a power electronic device comprises checking at the start of operation of the power electronic device whether exactly one activated power class profile from a number of different power class profiles is present. Only if exactly one activated power class profile is present is the device allowed to start operating under the conditions stored in the activated power class profile. The activated power class profile may have been selected by the installer from the number of different power class profiles during installation, or it may have already been activated at the factory or at another point in the supply chain, for example by a distributor.

A power class profile is, for example, a data record stored in the device, in particular a license file, which allows the device's operating system to check whether the device can be operated with a parameter set assigned to the power class profile and also allows permanent identification that the device is to be operated with this parameter set. For example, the data record may also contain the parameter set under which the device is to be operated. The power class profile does not have to contain all operating parameters and can also contain or define a selection of values permissible for operation or a permissible range of values for parameters. The term ‘power class profile’ does not imply that one of the parameters must necessarily be a power, for example, a rated power of the power electronic device.

The data set may also contain information about the device identification of the device for which the data set is intended to be activated. This effectively prevents a device other than the intended device from being put into operation by the data set, for example, by simply copying the data set. An advantageous option is to encrypt, sign or otherwise mark the data set in such a way that it can only be decrypted or used in a power electronic device with the intended device identification and/or with additional key components that are permanently stored in the device.

The device may contain a plurality of activatable power class profiles, but no more than one profile may be marked for operational use, i.e. activated. The marking may, for example, be a specific entry in the data record or a storage location for the data record. To prevent misuse, the data record may be encrypted and/or signed or stored in a memory area of the device to which access is restricted and only permitted if security criteria are met or sufficient authorization is provided.

In principle, the power electronic device may only have one activatable power class profile, but it is advantageous in one embodiment to have a plurality of activatable power class profiles, of which only one is activated to allow operation to begin. It is conceivable that when the selected power class profile is activated, the remaining profiles are deleted from the power electronic device, but they can also remain on the device as deactivated power class profiles so that they can be activated as replacements at a later point in time if necessary.

Furthermore, the method according to the disclosure comprises, in response to receiving a request for deactivation sent by an authorized person, converting the activated power class profile into a deactivated power class profile and sending a deactivation confirmation signed with a secret stored on the device to the authorized person, wherein the deactivation confirmation comprises an identification of the device and an identification of the deactivated power class profile. The signature ensures that no fake deactivation confirmations can be generated by unauthorized persons. At the same time, the signed deactivation confirmation ensures that the power class profile contained therein was activated and deactivated on the device identified by the identification. The deactivation confirmation can therefore be used like a single-use voucher for activating the power class profile contained therein on another device.

Sending a deactivation confirmation signed with a secret stored on the device to the authorized party also includes cases where the deactivation confirmation is sent to an authorized entity, such as a portal of the device manufacturer, where the authorized party can confirm receipt.

In order to further protect the process against data loss, the activated power class profile may only be converted into a deactivated power class profile after receipt of a confirmation of receipt of the deactivation confirmation from the authorized person. This also includes cases where the confirmation of receipt is sent by an authorized entity, such as a portal of the device manufacturer. The sending of the confirmation of receipt can also be effected by the authorized person registering the deactivation confirmation with the instance.

In order to prevent unintentional manipulation of the procedure and thus harmful, unauthorized deactivation of the power electronic device, in an advantageous embodiment, the conversion of the activated power class profile into a deactivated power class profile can only take place after successful verification of authorization for the deactivation request. For example, it may be provided that only the original installer or a person in possession of a predetermined secret, such as a data key, can effectively send the request for conversion to the device. Possession can be verified using known cryptographic methods such as the Diffie-Hellman method.

In order to reliably prevent unauthorized recommissioning of the power electronic device, the conversion of the activated power class profile may include deleting it. Similarly, the conversion may include immediately terminating the operation of the device so that unauthorized continued operation is also prevented.

In a further aspect relating to the commissioning of a replacement device in place of a failed power electronic device, the method further comprises the act of, in response to a further request to activate a power class profile, wherein the further request includes proof of authorization for activation, an identification of the power class profile to be activated and an identification of the device to be activated, the power class profile to be activated is activated, provided that activation requirements are met. The activation requirements include an identity of the identification of the device to be activated with the identification of the device executing the method and a validity of the proof of authorization. The validity of the proof of authorization can be verified by a signature of the further request with a signature key of the sender of the further request. This signature can be authenticated by the electronic device in a known manner. The creation of a request that fulfils the activation requirements can be supported by an application that can, in one embodiment, be installed on a mobile device or a separate computing unit in such a way that the activation can be easily carried out by an authorized person. This action can be logged by the application and, if necessary, transmitted to a central instance, for example a portal of the device manufacturer, and/or released by the latter.

Furthermore, the activation requirements may include that no previously activated power class profile is available on the device. If a previously activated power class profile is available, the power class profile to be activated is not activated, and the sender of the further request is preferably informed of this by means of a corresponding response.

Alternatively, the activation of the power class profile to be activated may include the deactivation of any other activated power class profile that may already exist. In this case, too, the sender of the further request may be informed by means of a corresponding response. This response may include a further deactivation confirmation to enable further use of the deactivated power class profile on another device. The further deactivation confirmation may be signed with the secret stored on the device, wherein the further deactivation confirmation comprises an identification of the device and an identification of the further, deactivated power class profile. The choice between the two alternative options, in case of an activated power class profile already existing, may also be made in a dialogue with the sender of the further request.

In a further aspect of the disclosure, a power electronic device comprises a start-up module configured to check, when the device is started up, whether exactly one activated power class profile is present from a number of different power class profiles, and, if exactly one activated power class profile is present, to start up the device under the conditions stored in the activated power class profile, and otherwise not to start the device. Furthermore, the power electronic device comprises a deactivation module designed to check the authorization of a deactivation command received from an external unit, if the authorization is confirmed after checking, to convert the activated power class profile into a deactivated power class profile and to send a deactivation confirmation signed with a secret stored on the device to the external unit, wherein the deactivation confirmation comprises an identification of the device and a designation of the deactivated or deleted power class profile.

The power electronic device can be advantageously configured as an inverter. For example, the power class profile can comprise a maximum converter power. In one embodiment, the power class profile can additionally or alternatively comprise at least one of the following performance characteristics:
a maximum reactive power,
an activation option for a grid-forming operating mode, and
an activation option for a grid-supporting operating mode.

### BRIEF DESCRIPTION OF THE FIGURES

The disclosure is described below with reference to figures, of which

FIG. 1 shows an example of a device replacement process using the method according to the disclosure, and

FIG. 2 shows the structure of a power electronic device according to the disclosure.

### DETAILED DESCRIPTION

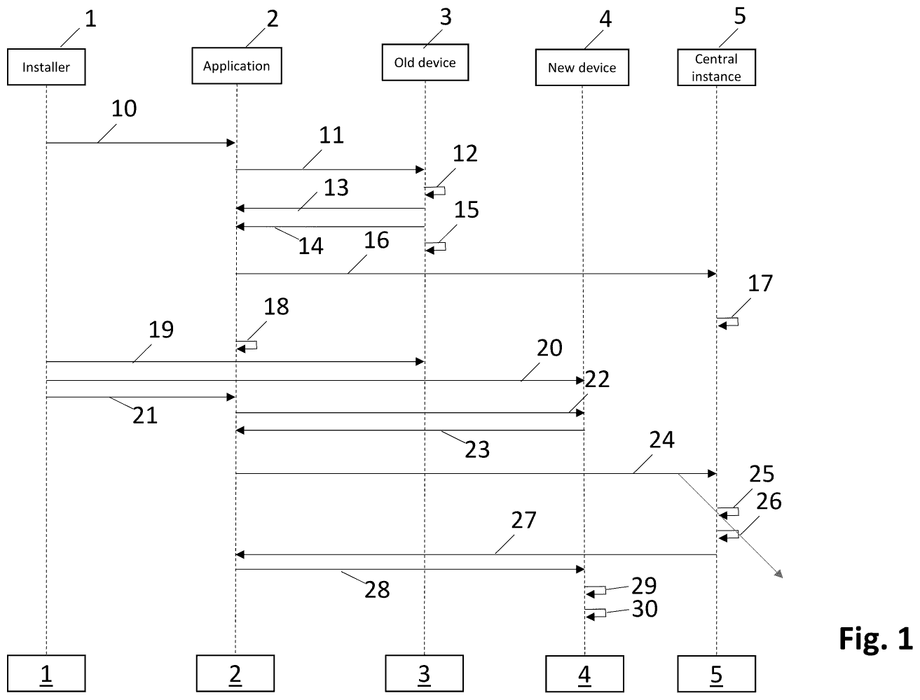

FIG. 1 shows an example of a device replacement process for a power electronic device according to the disclosure. The parties involved in the replacement are an installer 1, an application 2, in particular as an application on a mobile device of the installer 1, an old device 3 to be replaced, a new device 4 to replace the old device 3, and a central instance 5, which may in particular be a portal installed on a remote server and accessible via a remote data connection.

At the start of the process, installer 1 selects the function for initiating a device replacement in application 2 in a first action 10 in order to take the old device 3 out of service. Application 2 then sends a deactivation command to the old device 3 in a second action 11 and requests device identification from it. In response to receiving the deactivation command, the old device 3 deactivates its license file for the active power class profile in a third action 12. Furthermore, the old device 3 sends its device identification back to application 2 as requested in a fourth action 13. Optionally, the old device 3 sends a confirmation of the deactivation of the power class profile to the application 2 in a fifth action 14. This deactivation confirmation can also be sent together with the device identification in the fourth action 13 and can, for example and independently thereof, also contain the deactivated license file. Furthermore, the old device 3 ceases operation in a sixth action 15.

In one embodiment, the application 2 sends the deactivation confirmation together with the device identification of the old device 3 to the central instance 5 in a seventh action 16. Here, the deactivation of the old device 3 can be permanently registered in an eighth action 17 and/or the deactivated power class profile can be marked for later activation on a replacement device. As an alternative to the application 2, the old device 3 itself can also send the deactivation confirmation together with the device identification to the central instance 5.

Advantageously, application 2 also stores (e.g., permanently) the device identification and the deactivated power class profile or the deactivated license file in a ninth action 18 so that this information can be used at a later point in time to activate a power class profile for a replacement device. This simplifies the activation of a replacement device, as no data connection to the central instance 5 is required.

After completing the above actions, the installer 1 can remove the old device 3 in a tenth action 19 and, if necessary, dispose of it, have it repaired or even sell it. In an eleventh action 20, the installer can then install the new device 4 and start commissioning.

To commission the new device 4, the installer 1 selects the function for setting up a replacement device on the application 2 in a twelfth action 21. In a thirteenth action 22, the application 2 requests a device identification from the new device 4, which then sends its device identification back to the application 2 in a fourteenth action 23. After checking the device identification received to determine whether the new device 4 is suitable for activation using the deactivated power class profile of the old device 3, the application 2 sends a request to activate a power class profile in a fifteenth action 28, which includes information about the power class profile to be activated or the corresponding license file, to the new device 4, which activates the corresponding license file and enables operation to start with the associated power class profile (actions 29 and 30). The power class profile to be activated or the corresponding license file may already be stored on the new device 4 (as a power class profile that is still deactivated).

If the license file or the information about the power class profile to be activated is not stored on application 2 but only on the central instance 5, application 2 requests the information required to activate the power class profile from the central instance 5 (action 24), with the request containing the device identification of the old device 3, which is used to check the power class profile to be activated and the authorization for activation. If the request also contains the device identification of the new device 4, the central instance 5 can also check the suitability of the new device 4 for activation. The result of the check is then communicated to application 2. If the request is successful, the central instance 5 compiles the information for the power class profile to be activated or the corresponding license file (action 25) and sends it back to application 2, which can then complete the activation of the new device 4 (action 27). The central instance 5 marks the power class profile to be activated as used or deletes it permanently so that only a one-time (re)activation is possible and a new request to activate the same power class profile is unsuccessful. It is also conceivable to register the activated power class profile under the device identification of the new device 4.

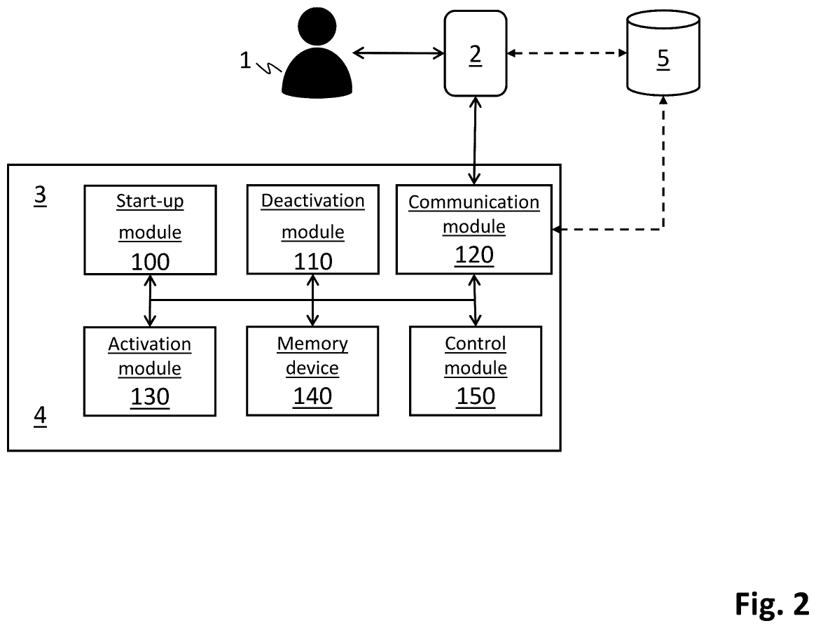

FIG. 2 shows an example of the structure of a power electronic device 34 according to the disclosure. The device comprises a communication module including circuitry 120 via which the device 34 can exchange data with an application 2 installed on a mobile device, for example a smartphone, or with a remote central instance 5. The data exchange can be wire-based or wireless via a radio connection. For example, the communication module or circuit 120 can be set up to establish and transmit data using a secure, for example encrypted, connection. Furthermore, the communication module 120 is set up to exchange data within the device 34 with other modules via a data bus. The individual modules can be designed as separate electronic components or as separate program components of a software architecture of an operating system of the device, or as hybrid combinations of both hardware and software.

The device 34 further comprises a start-up module or circuit 100 designed and intended to check, when the device starts up, whether exactly one activated power class profile is available from a number of different power class profiles, and, if exactly one activated power class profile is present, to start up the device under the conditions stored in the activated power class profile, and otherwise not to start up the device. For this purpose, the start-up module 100 reads from a secure area such as a memory device or circuit 140 in which the power class profiles are stored. If the check is successful, the start-up module 100 transmits a command to the control module or circuit 150 to start operation. This check is performed at the start of each operation so that operation of the device 34 is effectively prevented without an activated power class profile.

The device 34 also contains a deactivation module or circuit 110 designed and intended to check the authorization of a deactivation command received from an external unit, in this case a deactivation command triggered by an installer 1 during a device replacement using application 2, of an old device. Such a command is forwarded by the communication module 120 to the deactivation module 110. For this purpose, the deactivation command contains an identifier of the sender of the command, which is, in one embodiment, also compared with authorization information stored in the secure area 140.

If the authorization is confirmed after verification, the deactivation module 110 accesses the secure area 140 in write mode and converts the activated power class profile into a deactivated power class profile. This can be implemented by changing the power class profile or by deleting it. Furthermore, the deactivation module 110 causes a deactivation confirmation signed with a secret stored on the device to be sent back to the external unit via the communication module 120, wherein the deactivation confirmation includes an identification of the device and a label for the deactivated or deleted power class profile. With the help of this information, the sender can later activate an identical power class profile on a new device that replaces the old device.

The communication module 120 can alternatively or additionally send the deactivation confirmation to the central instance 5 for storage there, wherein the central instance confirms receipt to the application 2 if necessary.

The communication module 120 can alternatively or additionally send the deactivation confirmation to the central instance 5 for storage there, wherein the central instance of the application 2 confirms receipt if necessary.

In an advantageous embodiment, the power electronic device comprises an inverter.

Furthermore, the power electronic device 34 comprises an activation module or circuit 130, which is used in the context of device replacement when activating a power class profile on the new device. When the communication module 120 receives a request to activate a power class profile, it forwards this request to the activation module 130. The request contains an identification of the power class profile to be activated and an identification of the device to be activated, for example, its device identification. The request may also contain the power class profile to be activated itself. After checking the authorization of the sender of the request and the suitability of the power class profile to be activated on the device 34 (if necessary by comparing it with corresponding information stored in the secure area 140), the activation module 130 transfers the power class profile to be activated to the secure area 140 or changes the power class profile already present in the secure area 140 to an activated power class profile. If an activated power class profile already exists there, it can alternatively be deactivated, or the request to activate a power class profile is rejected.

The activation module 130 can send a message via the communication module 120 to the sender to indicate that the request to activate a power class profile has been implemented or rejected. Furthermore, the activation module 130 can report a successful activation directly to the control module 150, which immediately initiates commissioning of the device 34 in accordance with the specifications of the activated power class profile.

What is claimed is:

1. A method for operating a power electronic device, comprising:
checking at a start of operation whether an activated power class profile from a number of different power class profiles is present, and allowing the power electronic device to start operating under conditions stored in the activated power class profile only if exactly one activated power class profile is present, and
in response to receiving an authorized deactivation request, converting the activated power class profile into a deactivated power class profile and sending to an authorization entity a deactivation confirmation signed by a secret stored on the power electronic device, wherein the deactivation confirmation comprises an identification of the power electronic device and an identification of the deactivated power class profile.

2. The method according to claim 1, wherein the converting of the activated power class profile into a deactivated power class profile takes place after receipt of a confirmation of receipt of the deactivation confirmation from the authorization entity.

3. The method according to claim 1, wherein converting of the activated power class profile into a deactivated power class profile only takes place after successful verification of an authorization of the authorized deactivation request.

4. The method according to claim 1, wherein converting of the activated power class profile into a deactivated power class profile comprises deleting the activated power class profile.

5. The method according to claim 1, wherein converting of the activated power class profile into a deactivated power class profile comprises terminating an operation of the power electronic device.

6. The method according to claim 1, further comprising in response to a further request to activate a power class profile, wherein the further request comprises proof of authorization for activation, identification of the power class profile to be activated and identification of the power electronic device to be activated:
activating the power class profile to be activated, provided that activation prerequisites are met, wherein the activation prerequisites comprise an identity of the identification of the power electronic device to be activated with the identification of the power electronic device executing the method and a validity of the proof of authorization.

7. The method according to claim 6, wherein the activation prerequisites further comprise that no already activated power class profile is present on the power electronic device.

8. The method according to claim 6, wherein activating the power class profile to be activated comprises deactivating any other activated power class profile that is present.

9. The method according to claim 8, wherein deactivating an already existing power class profile comprises sending a further deactivation confirmation signed with the secret stored on the power electronic device, wherein the further deactivation confirmation comprises an identification of the power electronic device and an identification of the further, deactivated power class profile.

10. A power electronic device, comprising:
a start-up module configured to check, when the power electronic device starts operating, whether one activated power class profile is present from a number of different power class profiles, and, if exactly one activated power class profile is present, to start the device under conditions stored in the activated power class profile, and otherwise not to start the power electronic device, and
a deactivation module configured to check an authorization of a deactivation command received from an external unit and, if the authorization is confirmed after checking, to convert the activated power class profile into a deactivated power class profile and to send a deactivation confirmation signed with a secret stored on the power electronic device to the external unit, wherein the deactivation confirmation comprises an identification of the power electronic device and a marking of the deactivated or deleted power class profile.

11. The power electronic device according to claim 10, wherein the power electronic device comprises an inverter.

12. The power electronic device according to claim 11, wherein the power class profile comprises a maximum converter power.

13. The power electronic device according to claim 11, wherein the power class profile comprises at least one of the following performance characteristics:
a maximum reactive power,
an activation option for a grid-forming operating mode, and
an activation option for a grid-supporting operating mode.

14. The power electronic device according to claim 10, further comprising an activation module configured to perform, in response to a further request for activation of a power class profile, wherein the further request comprises proof of authorization for activation, identification of the power class profile to be activated and identification of the device to be activated,
activating the power class profile to be activated, provided that activation prerequisites are met, wherein the activation prerequisites comprise an identity of the identification of the power electronic device to be activated with the identification of the power electronic device executing a method and a validity of the proof of authorization.
